(19) United States
(12) Patent Application Publication
(10) Pub. No.: US 2017/0337194 A1
(43) Pub. Date: Nov. 23, 2017

(54) VISUALIZING DOCUMENT ACTIVITY

(71) Applicant: Microsoft Technology Licensing, LLC, Redmond, WA (US)

(72) Inventors: Ronald Kent Gilchrist, Seattle, WA (US); Christopher Lee Mullins, Sammamish, WA (US); Robert Earl Standefer, III, Duvall, WA (US)

(21) Appl. No.: 15/157,264

(22) Filed: May 17, 2016

(51) Int. Cl. G06F 17/30; G06F 3/0484; G06F 17/21; G06F 3/0482

(52) U.S. Cl. CPC G06F 17/30011; G06F 17/30601; G06F 3/0482; G06F 3/04842; G06F 17/212

(57) ABSTRACT

A facility for visualizing document information is described. The facility causes to be displayed content of a document. Concurrently with the document content, the facility causes to be displayed a document information visualization area, the displayed document information visualization area including, for each of one or more categories of document interactions, a visual indication of a set of result values aggregated from individual document interaction events of the category.

### BACKGROUND

Word processing applications permit users to create and revise documents having contents such as text and tables. Some conventional word processing applications have mechanisms that can be used to track revisions to a document each made by a particular person at a particular time, and display these revisions in the context of a document.

### SUMMARY

This summary is provided to introduce a selection of concepts in a simplified form that are further described below in the Detailed Description. This summary is not intended to identify key factors or essential features of the claimed subject matter, nor is it intended to be used to limit the scope of the claimed subject matter.

A facility for visualizing document information is described. The facility causes to be displayed content of a document. Concurrently with the document content, the facility causes to be displayed a document information visualization area, the displayed document information visualization area including, for each of one or more categories of document interactions, a visual indication of a set of result values aggregated from individual document interaction events of the category.

### BRIEF DESCRIPTION OF THE DRAWINGS

FIG. 1 is a block diagram showing some of the components typically incorporated in at least some of the computer systems and other devices on which the facility operates.

FIG. 2 is a flow diagram showing a process performed by the facility in some embodiments to compile document interaction information.

FIG. 3 is a data diagram showing data stored and/or accessed by the facility in some embodiments.

FIG. 4 is a flow diagram showing a process performed by the facility in some embodiments to aggregate interaction events for a particular document.

FIG. 5 is a flow diagram showing a process performed by the facility in some embodiments to display an interaction visualization area for a document that reflects the result of aggregating interaction events for the document for each of one or more interaction categories.

FIGS. 6-10 are display diagrams each showing an example of the facility displaying a document activity visualization area for a sample document.

### DETAILED DESCRIPTION

The inventors have recognized that people perform a rich variety of interactions with documents whose review and analysis can yield valuable insights. The inventors have further observed, however, that conventional applications for creating and revising word processing documents and documents of other types do very little to deliver information about such interactions, particularly in ways that are useful or flexible.

Accordingly, the inventors have conceived and reduced to practice a software and/or hardware facility for visualizing interactions performed with respect to a document (“the facility”). In some embodiments, the facility tracks user interactions of a variety of types with documents, storing information for each such as its type, the identity of the user that performed it, the time at which it was performed, the identity of the document with which it was performed, the point in that document at which it was performed, substantive information about the interaction such as text that was inserted in a revision interaction, etc.

Together with contents of a document, the facility displays a visualization area containing one or more visualization elements. Each visualization element identifies a category of interactions with the document and a visual representation of the result of aggregating and/or grouping interactions with the document that are in that category. For example, for a particular document, the facility may display a visualization area containing visualization elements that (1) identify the users who have most frequently performed a view interaction with the document; (2) show the frequency with which each section of the document has been viewed; and (3) show the users who have made the most comments on the document, such as by using pie graphs. In various embodiments, the facility provides an interface for users to manipulate the visualization elements of the visualization area, such as adding them, deleting them, altering their categories, changing their visual representation forms, drilling into them to obtain more detailed information, etc. In some embodiments, the facility displays a filtering timeline in the visualization area, and enables the user to select a subrange of the range of time it portrays. In response, the facility filters the document interactions represented in each of the visualization elements to include only the interactions occurring during the subrange selected by the user. In some embodiments, the facility displays a time-series graph in connection with the timeline that shows the occurrence of interactions of a particular interaction type with respect to the document over time, such as an interaction type selected by the user.

In various embodiments, the facility allows users to visualize information about a wide variety of types of document interactions, including but not limited to: a Share interaction, in which a user shares a document or a portion of a document with one or more other users; a Give interaction, in which a user gives a document or a portion of a document to one or more other users; a Withdraw interaction, in which a user withdraws a document or a portion of a document from availability to one or more other users; a Comment interaction, in which a user creates a comment discussing a document or a portion of a document; an Annotate interaction, in which a user attaches a note to a document or a portion of a document; a View interaction, in which a user displays or reads a document or a portion of a document; a Redact interaction, in which a user makes a document or a portion of a document unavailable to one or more users; an Expose interaction, in which a user exposes a portion of a document to one or more users; a Revise or Edit interaction, in which a user changes the document or portion of a document; a Contribute interaction, in which a user offers a contribution to a document or a portion of a document to an author or manager of the document; a Compose interaction, in which a user composes a document or a portion of a document; an Arrange interaction, in which the user arranges portions of a document relative to one another; a Notify interaction, in which a user registers to be notified about certain kinds of interactions with the document or a portion of a document; a Discuss interaction, in which a user discusses a document or a portion of a document; a Pin interaction, in which a user generates a persistent copy of the current state of a document or a portion of a document; a Tag interaction, in which a user tags a document or a portion of a document for easier later reference, an Approve interaction, in which a user allows another user to take particular action with respect to a document or a portion of a document, such as revising it or incorporating it into another document; a Deny interaction, in which a user refuses to allow another user to take particular action with respect to a document or a portion of a document; a Rate interaction, in which a user specifies a rating for a document or a portion of a document; an Execute interaction, in which a user signs or otherwise executes a document or a portion of a document; a Complete interaction, in which a user designates a document or a portion of a document as complete; a Delegate interaction, in which a user delegate some action and/or privilege with respect to a document or a portion of a document to another user; a Revise interaction, in which a user changes the contents of a document or a portion of a document; or a Revert interaction, in which a user reverts a document or a portion of a document to its content at an earlier time.

In some embodiments, the facility performs various kinds of aggregations on qualifying interactions in a category to obtain an aggregation result depicted in the visualization elements, using aggregations such as count, minimum, maximum, mean, median, etc. for example, the facility may use the count aggregation function to determine the total number of Edit interactions, while the facility may use the mean aggregation function to determine the average rating ascribed among Rate interactions. In some embodiments, the facility filters document interactions with the document before aggregating them, such as by filtering them to include only interactions of a particular type or group of types; interactions performed by users in a particular group, defined in various ways; interactions performed from a particular geographic location or region; interactions performed during a particular time period of any scale; interactions performed in a particular portion of the document; etc. In some embodiments, the facility groups document interactions on the basis of factors such as of any of the factors listed above.

In some embodiments, the facility enables the user to select a portion of the document—either a predefined portion or part of the document chosen contemporaneously by the user—as a basis for the information displayed in the visualization elements of the visualization area. In various embodiments, the facility operates with respect to document portions of a variety of kinds, including such nonexclusive examples as sections, pages, columns, paragraphs, lines, sentences, nodes of a graph making up a document, outline elements, spreadsheet cells, spreadsheet tabs, graphs, etc. These can occur in documents of a wide variety of types, including textual word processing documents; spreadsheets; slideshow documents; outline documents; lay, technical or architectural drawings documents; artistic documents; timeline documents; database records; webpage documents; emails and other types of messaging documents; etc.

By performing in some or all of the ways described above, the facility provides a wealth of information on the behavior of users with respect to documents and their individual portions, and ultimately on their significance and usefulness.

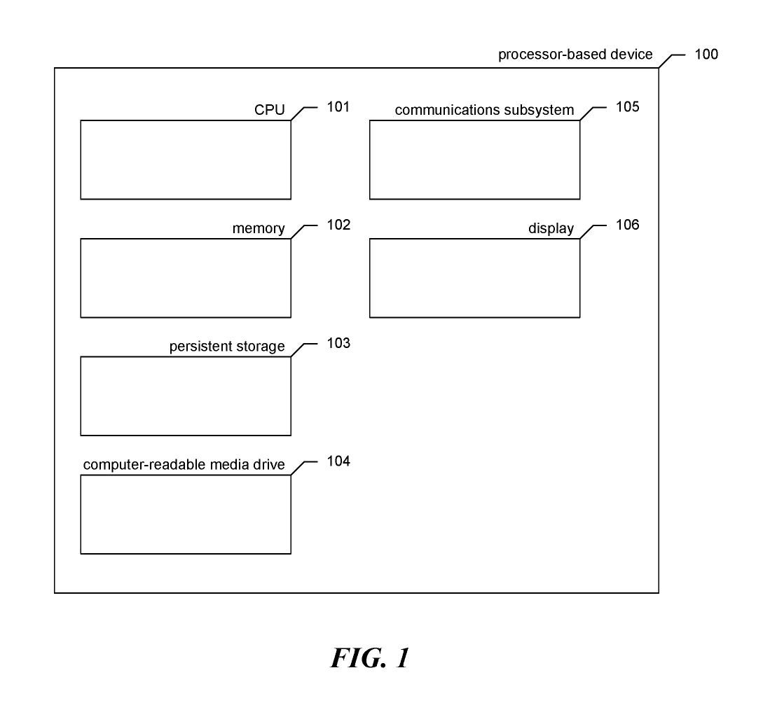

FIG. 1 is a block diagram showing some of the components typically incorporated in at least some of the computer systems and other devices on which the facility operates. In various embodiments, these computer systems and other devices 100 can include server computer systems, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (“CPU”) 101 for executing computer programs; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like; and a display device 106 for producing visual output. While computer systems configured as described above are typically used to support the operation of the facility, those skilled in the art will appreciate that the facility may be implemented using devices of various types and configurations, and having various components.

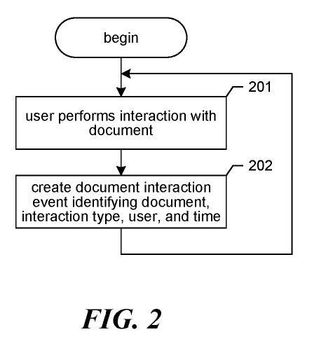

FIG. 2 is a flow diagram showing a process performed by the facility in some embodiments to compile document interaction information. In act 201, the facility observes a user performing interaction with the document. In various embodiments, the facility does so based upon integration with or observation of the application, a document management system, or the device being used by the user, for example. In act 202, the facility creates and stores a document interaction event that, in some embodiments, includes such information as the interaction's type, the identity of the user that performed it, the time at which it was performed, the identity of the document with which it was performed, the point in that document at which it was performed, substantive information about the interaction such as text that was inserted in a revision interaction, etc. In some embodiments (not shown), the facility tracks, stores, aggregates interactions performed by an actor other than a person, such as an Al agent that performs grammar corrections, security classifications, etc. After act 202, the facility continues in act 201 to observe the next interaction.

Those skilled in the art will appreciate that the acts shown in FIG. 2 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

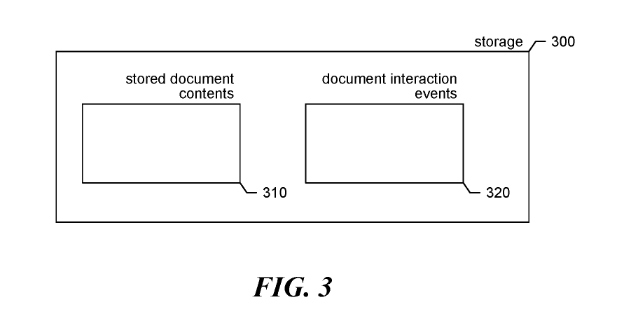

FIG. 3 is a data diagram showing data stored and/or accessed by the facility in some embodiments. One or more storage devices 300 contain the contents of documents and/or document portions, such as the contents of document nodes. Storage devices further contain document interaction events, such as the document interaction events stored in act 202 shown in FIG. 2.

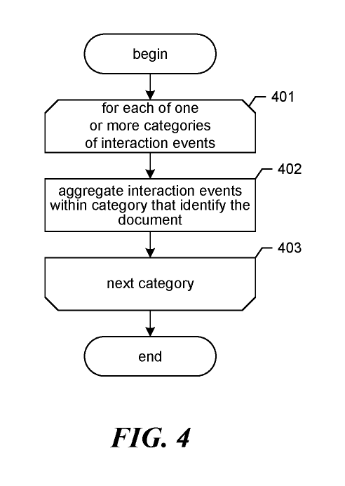

FIG. 4 is a flow diagram showing a process performed by the facility in some embodiments to aggregate interaction events for a particular document. In various embodiments, the facility performs this process as part of opening the document; peremptorily, in advance of opening the document; as part of displaying interaction visualization elements in the visualization area; etc. In acts 401-403, the facility loops through each of one or more categories of interaction events, such as categories for which interaction visualization elements are presently selected, or categories for which interaction visualization elements are to be available. In act 402, the facility aggregates interaction events within the current category that identify the document. In some embodiments, act 402 involves filtering and/or grouping these interaction events based upon various factors. In act 403, if additional categories remain to be processed, then the facility continues in act 401 to process the next category, else this process concludes.

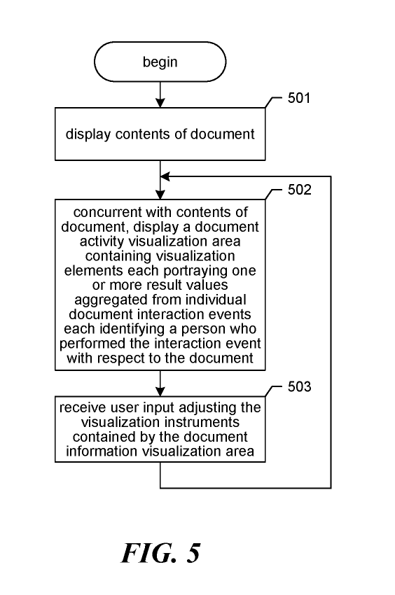

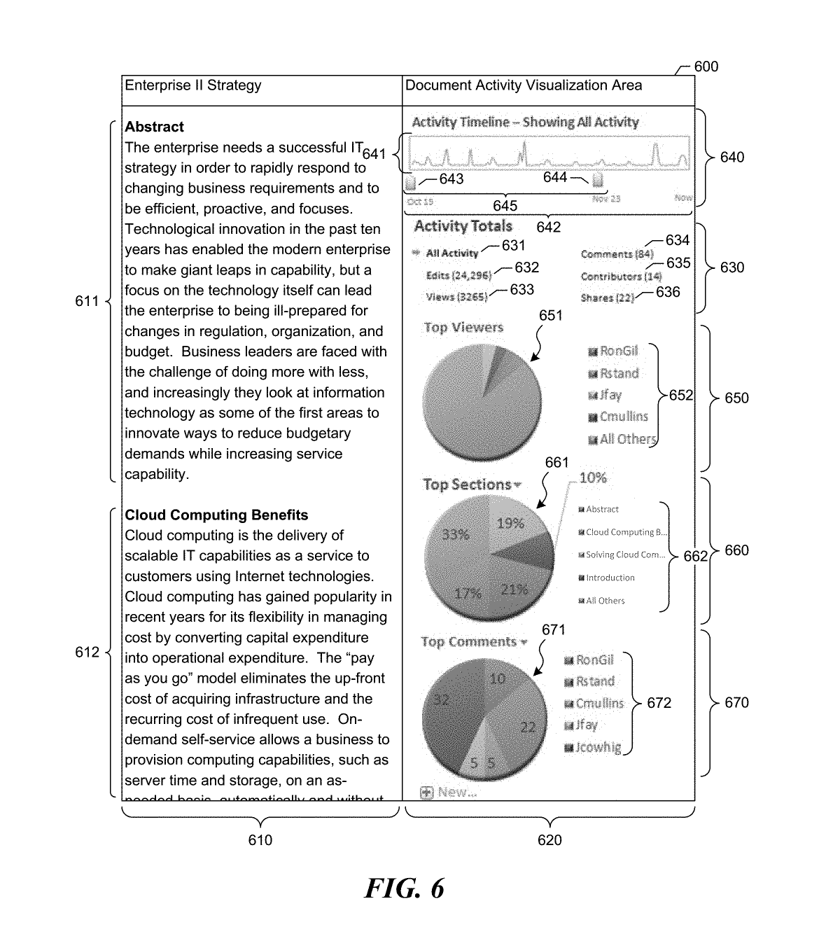

FIG. 5 is a flow diagram showing a process performed by the facility in some embodiments to display an interaction visualization area for a document that reflects the result of aggregating interaction events for the document for each of one or more interaction categories. In act 501, the facility causes contents of the document to be displayed. In act 502, while contents of the document are displayed, the facility displays the document activity visualization area. The visualization area contains visualization elements that each portray result values aggregated from individual document interaction events. Examples showing the facility's performance of acts 502 and 503 are shown in FIGS. 6-10 and discussed below. After act 503, the facility continues in act 502 to redisplay the visualization area, adjusted in accordance with the received use input.

FIGS. 6-10 are display diagrams each showing an example of the facility displaying a document activity visualization area for a sample document. FIG. 6 shows a first state of a document activity visualization area for the sample document. The display 600 includes contents 610 of the document “Enterprise II Strategy,” including an “Abstract” section 611 and a “Cloud Computing Benefits” section 612. The document activity visualization area 620 includes activity visualization elements 650, 660, and 670. Visualization element 650 is a pie chart 651 showing, among the users who performed the most View interactions with respect to the document, the relative number of times that each perform the View interaction. This pie chart 651 is accompanied by a key 652 identifying these users. Visualization element 660 is a pie chart 661 showing the relative number of view interactions performed with respect to each section of the document, and is accompanied by a key 662 identifying these. Visualization element 670 is a pie chart 671 showing the number of Comment interactions performed with respect to the document by each of the users who performed the most of these, and is accompanied by a key 672 identifying these users.

The document activity visualization area also includes a master timeline 640. The master timeline depicts a range of time, such as the range of time from the time at which the document was created to the present time. The master timeline also includes two slider thumbs 643 and 644 that the user can reposition—such as by grabbing and dragging them with a mouse, a stylus, or the user's finger—to redefine a subrange 645 of the entire range of time. In some embodiments, the facility uses this subrange to filter the interaction events represented in visualization elements 650, 660, and 670. For example, moving slider thumb 644 to the right (later in time) is likely to increase the number of interaction events represented among each of the visualization elements, while moving slider thumb 644 to the left (earlier in time) is likely to decrease the number of interaction events represented among each of the visualization events. The timeline also includes a time series graph 641 showing, at each point during the entire range of time, the number of interaction events of all types performed with respect to the document.

The document activity visualization area also includes a list 630 of certain interaction types, including all interaction types 631, Edit interaction type 632, View interaction type 633, Comment interaction type 634, Contribute interaction type 635, and Share interaction type 636. The user can select any of these—such as by touching or clicking on one—in order to change the interaction type for which the facility displays time series graph 641 in the timeline. It can be seen from the arrow to the left of all interaction types 631 that this interaction type is presently selected to be the basis for time series graph 641. In some embodiments, as shown, the facility displays in parentheses after each listed interaction type the number of occurrences of the interaction type that occurred during the time subrange. In some embodiments, not shown, the facility instead displays in these parentheses the number of occurrences of the interaction type that occurred during the entire range of time.

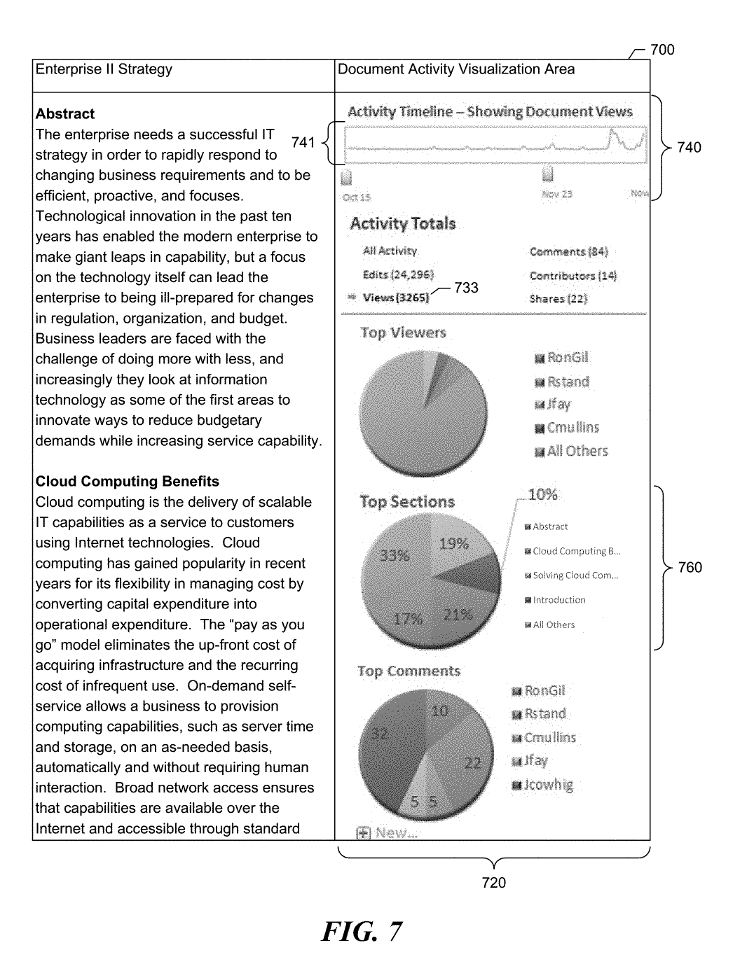

FIG. 7 shows a second state of the document activity visualization area for the sample document. The display 700 reflects selection of the Views interaction type 633 shown in FIG. 6. In particular, the document activity visualization area 720 shown in display 700 includes a time series graph 741 showing occurrences of the Views interaction type 733. The arrow to the left of Views interaction type 733 identifies this interaction type as being currently selected.

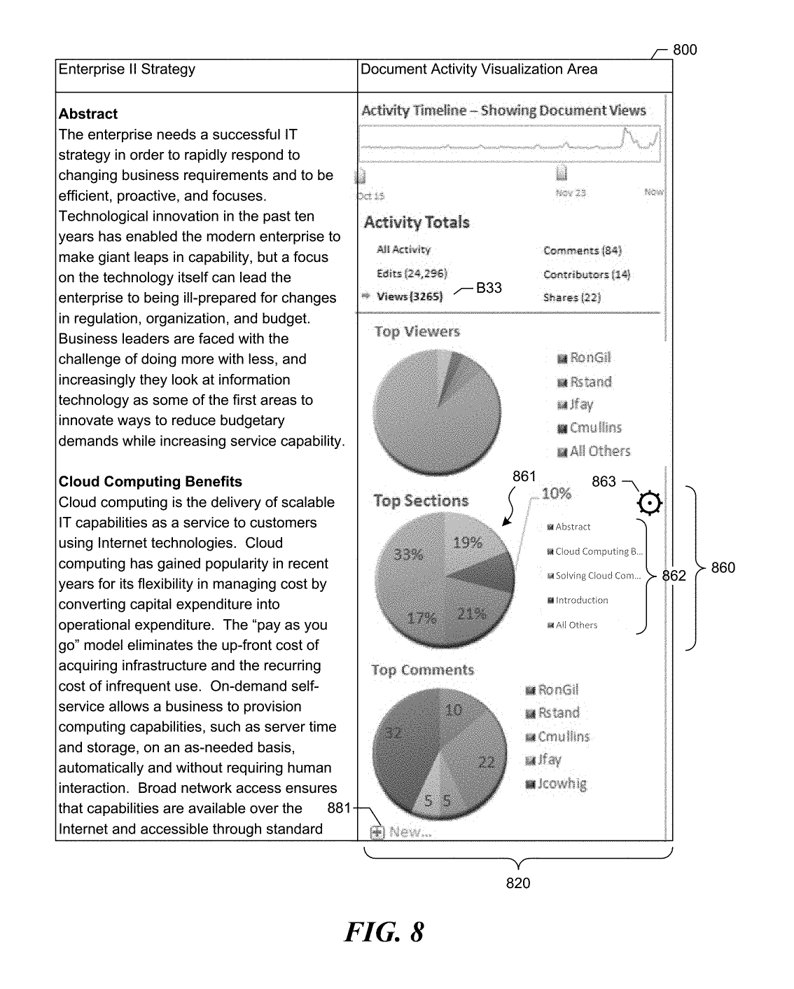

FIG. 8 shows a third state of the document activity visualization area for the sample document. The display 800 reflects hovering over visualization element 760 shown in FIG. 7. In particular, the document activity visualization area 820 shown in display 800 includes, for visualization element 860, a temporarily-displayed modification control 863 that the user may activate in order to change the category to which the visualization element corresponds and/or the form in which the visualization element is displayed. The document activity visualization area 820 also contains a new visualization element control 881 that the user may activate in order to add an additional visualization element to those shown in FIG. 8. In some embodiments, when the user does so, the facility scales down the size of the constituent parts of the visualization area to all fit simultaneously in the display. In some embodiments, when the user does so, the facility enables the user to scroll the contents of the visualization area to display each constituent part at its original size.

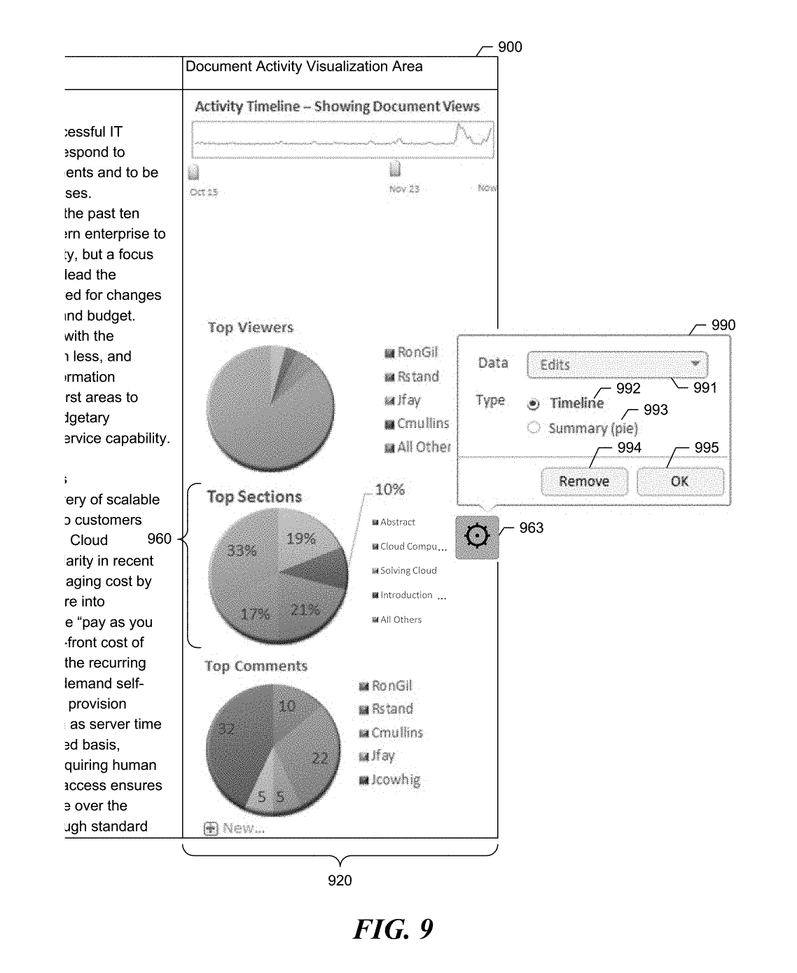

FIG. 9 shows a fourth state of the document activity visualization area for the sample document. The display 900 reflects activation of the modification control 863 shown in FIG. 8. In response, the facility displays modification window 990 that the user may use to change the category to which visualization element 960 corresponds and/or the form in which this visualization element is displayed. In particular, the user can select the interaction type or other category to be shown in the visualization element from drop-down list 991. The user can further select the form in which the visualization element is displayed, such as by selecting timeline form 992 or pie chart form 993. Once the user is satisfied with his or her selections, the user can activate an OK button 995 to put these selections into effect. User can also activate remote button 994 to remove the visualization element from the list of displayed visualization elements.

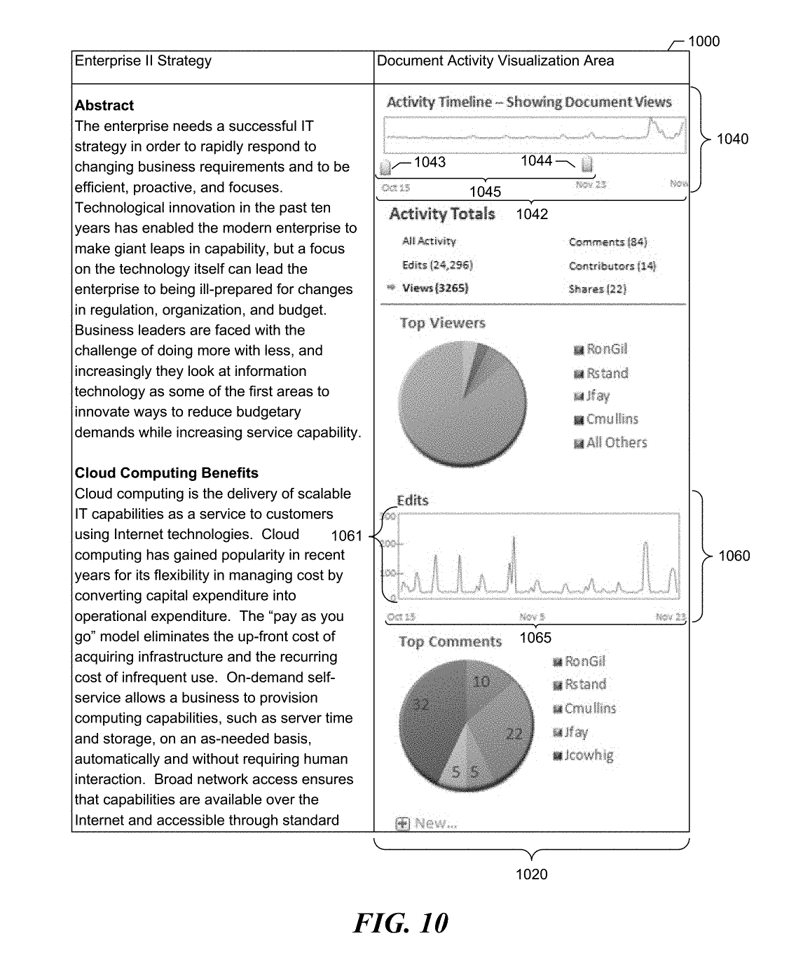

FIG. 10 shows a fifth state of the document activity visualization area for the sample document. The display 1000 reflects, in FIG. 9: selecting the Edit interaction type from drop-down list 991, selecting the timeline form 992, and activating the OK button 995. In response, the facility replaces visualization element 960 shown in FIG. 9 with visualization element 1060 shown in FIG. 10. It can be seen that replacement visualization element 1060 is a timeline visualization element reflecting Edit interaction events, as specified by the user. It can further be seen that the time range 1065 of timeline visualization element 1060—October 15 to November 23—corresponds to the subrange 1045 defined in master timeline 1040 by the position of slider thumbs 1043 and 1044. Now moving the slider thumbs would have the effect of changing time range 1065 of timeline visualization element 1060.

In some embodiments, the facility provides a processor-based device, comprising: a display; a processor; and a memory having contents that cause the processor to: display at least some of the content of a document; display a timeline representing a range of time; receive user input selecting a subrange of the range of time represented by the displayed timeline; access a set of user interactions performed with respect to the document, each user interaction of the set identifying a category of the user interaction and a time at which the user interaction was performed; for each of one or more categories of user interactions: select only those user interactions of the set identifying the category and identifying a time during the selected subrange of time; aggregate the user an action selected for the category to obtain an aggregation result; and display a visual representation of the aggregation result together with a visual indication of the category.

In some embodiments, the facility provides a computer-readable medium having contents configured to cause a computing system to: display at least some of the content of a document; display a timeline representing a range of time; receive user input selecting a subrange of the range of time represented by the displayed timeline; access a set of user interactions performed with respect to the document, each user interaction of the set identifying a category of the user interaction and a time at which the user interaction was performed; for each of one or more categories of user interactions: select only those user interactions of the set identifying the category and identifying a time during the selected subrange of time; aggregate the user an action selected for the category to obtain an aggregation result; and display a visual representation of the aggregation result together with a visual indication of the category.

In some embodiments, the facility provides a method comprising: displaying at least some of the content of a document; displaying a timeline representing a range of time; receiving user input selecting a subrange of the range of time represented by the displayed timeline; accessing a set of user interactions performed with respect to the document, each user interaction of the set identifying a category of the user interaction and a time at which the user interaction was performed; for each of one or more categories of user interactions: selecting only those user interactions of the set identifying the category and identifying a time during the selected subrange of time; aggregating the user an action selected for the category to obtain an aggregation result; and displaying a visual representation of the aggregation result together with a visual indication of the category.

In some embodiments, the facility provides a computer-readable medium having contents configured to cause a computing system to: display a visual representation of at least a portion of a document; and concurrently with and proximate to the visual representation, display a document information visualization area, the displayed document information visualization area including, for each of one or more categories of document interactions, a visual indication of a set of result values aggregated from individual document interaction events of the category, each individual document interaction event identifying a person who performed the individual document interaction event.

In some embodiments, the facility provides a processor-based device, comprising: a display; a processor; and a memory having contents that cause the processor to: display a visual representation of at least a portion of a document; and concurrently with and proximate to the visual representation, display a document information visualization area, the displayed document information visualization area including, for each of one or more categories of document interactions, a visual indication of a set of result values aggregated from individual document interaction events of the category, each individual document interaction event identifying a person who performed the individual document interaction event.

In some embodiments, the facility provides a method in a computing system, comprising: causing to be displayed content of a document; and concurrently with the document content, causing to be displayed a document information visualization area, the displayed document information visualization area including, for each of one or more categories of document interactions, a visual indication of a set of result values aggregated from individual document interaction events of the category.

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

1. A processor-based device, comprising:
a display;
a processor; and
a memory having contents that cause the processor to:
display at least some of the content of a document;
display a timeline representing a range of time;
receive user input selecting a subrange of the range of time represented by the displayed timeline;
access a set of user interactions performed with respect to the document, each user interaction of the set identifying a category of the user interaction and a time at which the user interaction was performed;
for each of one or more categories of user interactions:
select only those user interactions of the set identifying the category and identifying a time during the selected subrange of time;
aggregate the user interactions selected for the category to obtain an aggregation result; and
display a visual representation of the aggregation result together with a visual indication of the category.

2. The device of claim 1 wherein the memory has contents that cause the processor to further:
for an initial user interaction type, displaying in connection with the timeline a time series aggregation of user interactions of the initial user interaction type.

3. The device of claim 2 wherein the memory has contents that cause the processor to further:
present a control for selecting a new user interaction type;
receive input operating the presented control to select a new user interaction type; and
in place of the time series aggregation of user interactions of the initial user interaction type, displaying a time series aggregation of user interactions of the new user interaction type.

4. A computer-readable medium having contents configured to cause a computing system to:
display a visual representation of at least a portion of a document; and
concurrently with and proximate to the visual representation, display a document information visualization area, the displayed document information visualization area including, for each of one or more categories of document interactions, a visual indication of a set of result values aggregated from individual document interaction events of the category, each individual document interaction event identifying an actor who performed the individual document interaction event.

5. The computer-readable medium of claim 4 wherein each document interaction event identifies an interaction type,
and wherein at least one category is defined at least in part by an interaction type.

6. The computer-readable medium of claim 5 wherein the interaction type defining one category is Share, Give, Withdraw, Comment, Annotate, View, Redact, Expose, Edit, Contribute, Compose, Arrange, Notify, Discuss, Pin, Tag, Approve, Deny, Revise, Revert, or Discuss.

7. The computer-readable medium of claim 4 wherein each document interaction event identifies an interaction type,
and wherein at least one category is defined at least in part by a list of interaction types.

8. The computer-readable medium of claim 4 wherein each document interaction event identifies a date,
and wherein at least one category is defined at least in part by a range of dates.

9. The computer-readable medium of claim 4 wherein at least one category is defined at least in part by the identity of a person.

10. The computer-readable medium of claim 4 wherein at least one category is defined at least in part by the identity of a group of people.

11. The computer-readable medium of claim 4 wherein a selected visual indication is displayed in an initial form,
and wherein the computer-readable medium has contents configured to further cause a computing system to:
receive user input specifying a form for the selected visual indication other than the initial form; and
in response to the received user input, redisplaying the selected visual indication in the form specified by the received user input.

12. The computer-readable medium of claim 4 wherein a selected visual indication has an initial category,
and wherein the computer-readable medium has contents configured to further cause a computing system to:
receive user input specifying a category for the selected visual indication other than the initial category; and
in response to the received user input, replacing the selected visual indication in the display with a visual indication for the category specified by the received user input.

13. The computer-readable medium of claim 4 wherein a selected visual indication is displayed in an initial form,
and wherein the computer-readable medium has contents configured to further cause a computing system to:
receive user input specifying a category of document interaction for which a visual indication is not displayed; and
in response to the received user input, including among the displayed visual indications a visual indication for the specified category of document interaction

14. The computer-readable medium of claim 4, having contents configured to further cause a computing system to:
display a timeline representing a range of time;
receiving user input selecting a subrange of the range of time represented by the displayed timeline; and
each time a new subrange is selected, redisplay the document information visualization area in a manner that includes, for each of the categories of document interactions, a visual indication of a set of result values aggregated from only those individual document interaction events of the category that occurred during the selected subrange of time.

15. The computer-readable medium of claim 4, having contents configured to further cause a computing system to:
receive user input selecting a displayed portion of the document; and
each time a new displayed portion of the document is selected, redisplay the document information visualization area in a manner that includes, for each of the categories of document interactions, a visual indication of a set of result values aggregated from only those individual document interaction events of the category that were performed with respect to the selected displayed portion.

16. A method in a computing system, comprising:
causing to be displayed content of a document; and
concurrently with the document content, causing to be displayed a document information visualization area, the displayed document information visualization area including, for each of one or more categories of document interactions, a visual indication of a set of result values aggregated from individual document interaction events of the category.

17. The method of claim 16, further comprising:
causing to be displayed a timeline representing a range of time;
receiving user input selecting a subrange of the range of time represented by the displayed timeline; and
each time a new subrange is selected, causing the document information visualization area to be redisplayed in a manner that includes, for each of the categories of document interactions, a visual indication of a set of result values aggregated from only those individual document interaction events of the category that occurred during the selected subrange of time.

18. The method of claim 16, further comprising:
receiving user input selecting a displayed portion of the document;
each time a new displayed portion of the document is selected, causing the document information visualization area to be redisplayed in a manner that includes, for each of the categories of document interactions, a visual indication of a set of result values aggregated from only those individual document interaction events of the category that were performed with respect to the selected displayed portion.

19. The method of claim 16 wherein each document interaction event identifies an interaction type,
and wherein at least one category is defined at least in part by an interaction type.

20. The method of claim 16 wherein each document interaction event identifies a date,
and wherein at least one category is defined at least in part by a range of dates.
